(19) United States
(12) Patent Application Publication
(10) Pub. No.: US 2018/0304677 A1
(43) Pub. Date: Oct. 25, 2018

(54) THREADED WHEEL ORNAMENT ATTACHMENT

(71) Applicant: FORD GLOBAL TECHNOLOGIES, LLC, Dearborn, MI (US)

(72) Inventor: Neal Koenig, New Hudson, MI (US)

(21) Appl. No.: 15/494,781

(22) Filed: Apr. 24, 2017

(51) Int. Cl. B60B 7/14; B60B 7/06; F16B 5/02

(52) U.S. Cl. CPC B60B 7/14; F16B 5/02; B60B 7/066

(57) ABSTRACT

A system for connecting a vehicle wheel attachment includes one or more threaded inserts each having an exteriorly threaded surface adapted to mate with a wheel hub central interiorly threaded bore. The wheel hub central interior threaded bore may be fabricated of a first material and the one or more threaded inserts may be fabricated of a second material that is different from the first material. The threaded inserts include an interiorly threaded surface adapted to mate with an exteriorly threaded flange carried by the vehicle wheel attachment. The threaded inserts may include an exteriorly threaded surface defining a same or a different exterior diameter from other threaded inserts, and may also include an interiorly threaded surface defining a same or a different interior diameter from other threaded inserts. Methods for connecting a wheel attachment to a wheel hum using the described system are provided.

### TECHNICAL FIELD

This document relates generally to the motor vehicle field and, more particularly, to a system and method for attaching a wheel ornament to a wheel hub of a motor vehicle wheel.

### BACKGROUND

Various devices are often attached to vehicle wheels, for utilitarian and/or ornamental purposes. For example, owners may desire to customize their vehicle, and as part of that process may attach ornaments to the wheel hub to alter the look of the wheel. Conventionally, such wheel ornaments/devices are attached by snap/interference fit features (commonly known in the art as “snap fits”). Such snap fits extend rearwardly from the wheel ornament/device and are biased radially outwardly around the circumference of the wheel ornament/device in order to engage a locking rib on the wheel to which the center cap is attached. A locking ring or other structure may then be provided to secure the connection.

Such snap fit attachments, while generally suitable for their intended purpose, lack the strength to safely support larger, heavier wheel ornaments or devices to be attached to the wheel such as electromechanical devices including motors and/or lighting systems. Further, no industry size/diameter standards have been established for wheel ornaments/devices providing for a good fit between different wheel makes/models, particularly for customized wheels. Accordingly, to solve this and other problems the present disclosure relates to a system and method for attaching a wheel ornament or other device to a wheel hub.

### SUMMARY

In accordance with the purposes and benefits as described herein a system for connecting a vehicle wheel attachment is provided, comprising a wheel hub fabricated of a first material and including an interiorly threaded bore and at least one threaded insert fabricated of a second material that is different from the first material and having an exteriorly threaded surface adapted to mate with the central interiorly threaded bore. The at least one threaded insert further includes an interiorly threaded surface adapted to mate with an exteriorly threaded flange carried by the vehicle wheel attachment. The vehicle wheel attachment may be a wheel ornament.

In embodiments, the system includes a plurality of threaded inserts each one having an exteriorly threaded surface defining an exterior diameter that is different from at least one other of the plurality of threaded inserts. The plurality of threaded inserts each further have an interiorly threaded surface defining an interior diameter that is different from at least one other of the plurality of threaded inserts.

In another aspect of the disclosure, a system for connecting a vehicle wheel attachment such as a wheel ornament is provided, comprising a plurality of threaded inserts as described above. The wheel hub central interior threaded bore is fabricated of a first material and the plurality of threaded inserts are fabricated of a second material that is different from the first material.

In yet another aspect, a method of connecting a wheel attachment to a vehicle wheel hub having a central interiorly threaded bore is provided, comprising modifying the central interiorly threaded bore to mate with an exteriorly threaded flange carried by the wheel attachment. The method includes providing a wheel hub fabricated of a first material and including a central interiorly threaded bore and providing at least one threaded insert fabricated of a second material that is different from the first material and having an exteriorly threaded surface adapted to mate with the central interiorly threaded bore. The at least one threaded insert includes an interiorly threaded surface adapted to mate with an exteriorly threaded flange carried by the vehicle wheel attachment. The method further includes mating the vehicle wheel attachment to the at least one threaded insert.

In embodiments, the method may include providing a plurality of threaded inserts each one having an exteriorly threaded surface defining an exterior diameter that is different from at least one other of the plurality of threaded inserts. The method may further include providing a plurality of threaded inserts each one having an interiorly threaded surface defining an interior diameter that is different from at least one other of the plurality of threaded inserts.

In other embodiments, the method may include tapping the central interiorly threaded bore to a desired interior diameter to mate with the at least one threaded insert exteriorly threaded surface. The method may further include mating the tapped central interiorly threaded bore to the at least one threaded insert exteriorly threaded surface. The method may further include mating the exteriorly threaded flange carried by the wheel attachment to the at least one threaded insert interiorly threaded surface.

In the following description, there are shown and described several preferred embodiments of systems for connecting a vehicle wheel attachment and associated methods. As it should be realized, the systems and associated devices and methods are capable of other, different embodiments and their several details are capable of modification in various, obvious aspects all without departing from the systems and methods as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of systems for connecting a vehicle wheel attachment and associated methods, and together with the description serve to explain certain principles thereof. In the drawing figures:

FIG. 1 is a cross-sectional view of a wheel hub including a central interiorly threaded bore.

FIG. 2A shows a cross-sectional view of an insert defining a different exterior and/or interior diameters;

FIG. 2B shows a cross-sectional view of an alternative embodiment of the insert of FIG. 2A;

FIG. 2C shows a cross-sectional view of another alternative embodiment of the insert of FIG. 2A; and

FIG. 3 is a cross-sectional view of an insert according to FIG. 2 matingly received in the wheel hub of FIG. 1, and including a wheel attachment adapted to be matingly received by the insert interiorly threaded surface.

Reference will now be made in detail to embodiments of the described systems for connecting a vehicle wheel attachment and associated methods, examples of which are illustrated in the accompanying drawing figures.

### DETAILED DESCRIPTION

Preliminarily, the systems and methods described herein is described primarily in the context of attaching a wheel ornament to a wheel hub. However, the skilled artisan will readily understand that the described systems and methods are easily adaptable to attach other devices to a wheel hub, for example electromechanical devices including motors and/or lighting systems and/or other decorative features. Accordingly, the descriptions herein will not be taken as limiting in this regard.

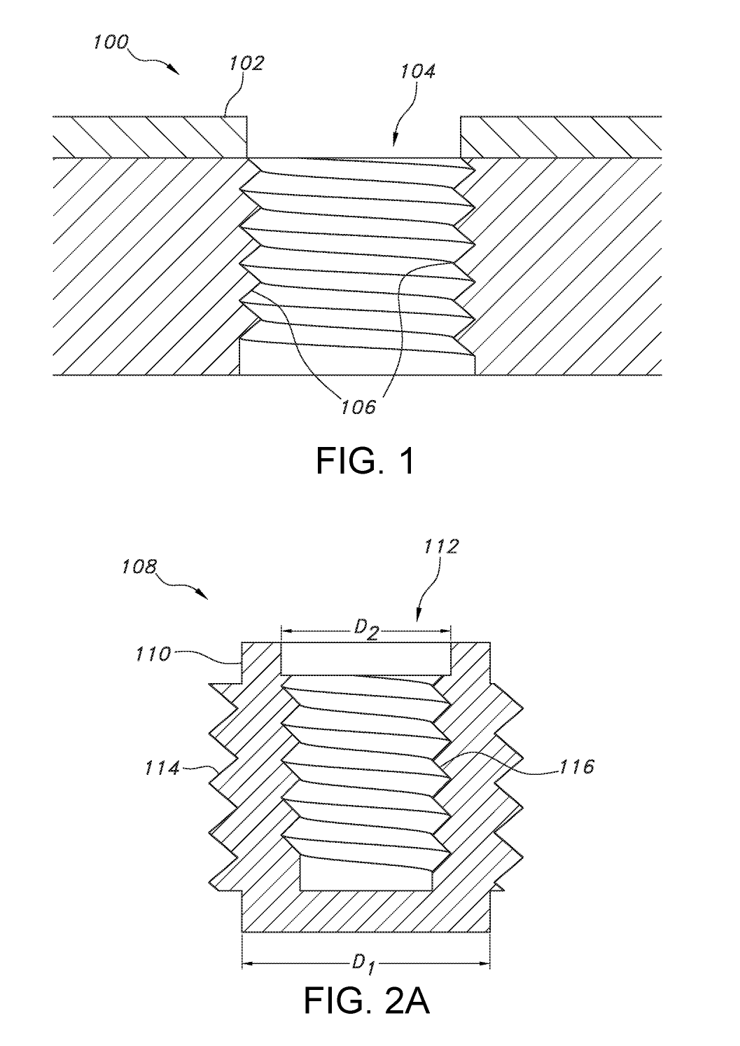

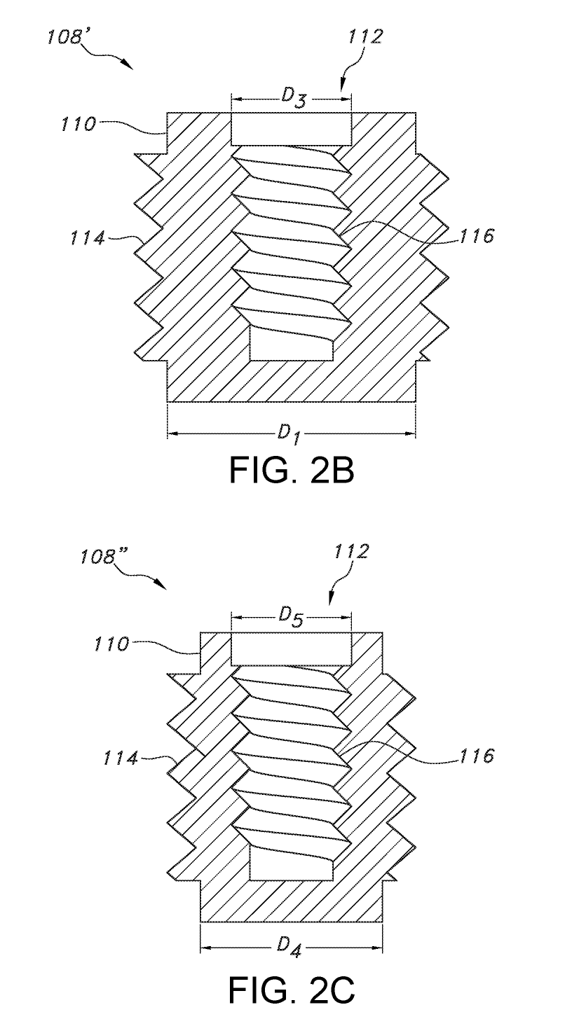

FIG. 1 shows a cross-sectional view of a wheel 100, including a central hub 102. The wheel 100 and/or wheel hub 102 may be fabricated of any suitable material, such as metals, alloys, polymers, and combinations. As shown, the central hub 102 includes a bore 104 having an interiorly threaded surface 106. The interiorly threaded surface 106 is adapted to mate with an insert 108 as shown in FIGS. 2A-C. As shown, the insert 108 includes a body 110 having at least a partial through-bore 112. The body 110 further includes an exteriorly threaded surface 114 and an interiorly threaded surface 116.

As shown in the drawing figures, multiple inserts 108 having a variety of external and internal diameters D may be provided. The inserts 108 may be manufactured of a same or a different material from the wheel 100/hub 102, such as a plastic or polymer, or a different metal or alloy. The material of the insert 108 may be selected for physical properties allowing the insert to be more easily fabricated, molded, and/or machined compared to the material of the wheel 100/hub 102. Each insert 108 may be configured whereby individual inserts may define a same and/or a different external and/or internal diameter compared to other inserts 108.

In the depicted embodiments, inserts 108, 108′, and 108″ are shown. As one non-limiting example, the insert 108 of FIG. 2A is configured to define an external diameter D1 and an internal diameter D2. The insert 108′ of FIG. 2B is configured to define an external diameter D1, but an internal diameter D3 that is different from than D2. On the other hand, the insert 108″ of FIG. 2C is configured to define an external diameter D4 that is different from D1 and an internal diameter D5 that is different from D2 and/or D3.

As will be appreciated, more or fewer inserts 108 may be provided, each defining external diameters and/or internal diameters that are the same and/or different from other inserts. By these inserts 108, as will be described below, the wheel hub central interiorly threaded bore 104 may be modified as necessary to accept wheel attachments having differently sized threaded flanges.

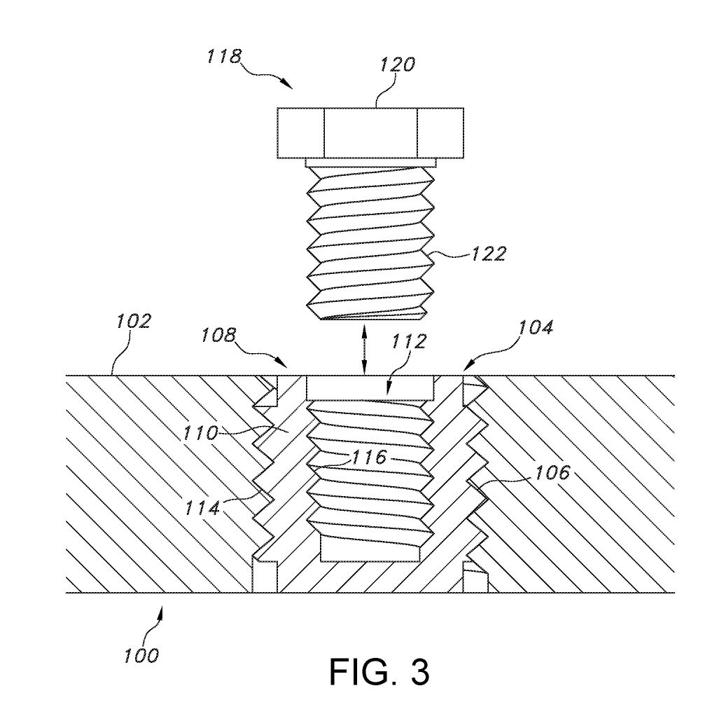

Specifically, as shown in FIG. 3 the insert 108 is mated with the wheel hub central interiorly threaded bore 104. In turn, the insert so placed defines a threaded receiver for a wheel attachment 118 including an ornamental or functional member 120 and an exteriorly threaded flange 122. As shown, the threaded flange 122 defines an exterior diameter D6 that matches an interior diameter D6 of the insert at least partial throughbore 112. Thus, by the cooperating threaded flange 122 and interiorly threaded surface 116, the wheel attachment 118 may be easily attached to the wheel hub 102.

In use, the wheel hub 102 may be fabricated with a central interiorly threaded bore 104 having a desired bore diameter, or may be tapped to provide the needed bore diameter and/or threading. A wheel attachment 118 having an exteriorly threaded flange 122 may be selected, and likewise an insert 108 may be selected having an interiorly threaded surface 116 configured to mate with the exteriorly threaded flange. If a different wheel attachment 118 (not shown) is later desired to be attached to the wheel hub 102, a different and suitably dimensioned insert 108 may be selected having an interiorly threaded surface 116 configured to mate with the exteriorly threaded flange 122 of the different wheel attachment.

It will be appreciated that by the foregoing described systems and associated methods, it is now possible to attach significantly larger and heavier devices such as wheel ornaments, electromechanical devices, devices including motors and/or lighting, etc. to a vehicle wheel compared to the size and/or weight of attachments that can be connected via conventional snap fit systems. In turn, the attaching is made simpler and more intuitive for both manufacturers and consumers compared to conventional snap fit systems for wheel ornaments, wheel caps, and the like. Still more, by the described systems and attendant methods, a convenient feature of interchangeability is provided, i.e. a variety of wheel attachments having different exterior threaded flange diameters can be attached to wheel hubs potentially including central interiorly threaded bores of different interior diameters, by modifying the vehicle wheel central hub as described. Thus, a single industry size standard for such devices is rendered unnecessary.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A system for connecting a vehicle wheel attachment, comprising:
a wheel hub fabricated of a first material and including an interiorly threaded bore; and
at least one threaded insert fabricated of a second material that is different from the first material and having an exteriorly threaded surface adapted to mate with the interiorly threaded bore.

2. The system of claim 1, wherein the at least one threaded insert includes an interiorly threaded surface adapted to mate with an exteriorly threaded flange carried by the vehicle wheel attachment.

3. The system of claim 1, including a plurality of threaded inserts each one having the exteriorly threaded surface defining an exterior diameter that is different from at least one other of the plurality of threaded inserts.

4. The system of claim 2, including a plurality of threaded inserts each one having the interiorly threaded surface defining an interior diameter that is different from at least one other of the plurality of threaded inserts.

5. The system of claim 1, wherein the vehicle wheel attachment is a wheel ornament.

6. A system for connecting a vehicle wheel attachment, comprising a plurality of threaded inserts each having an exteriorly threaded surface adapted to mate with a wheel hub central interiorly threaded bore.

7. The system of claim 6, wherein the wheel hub central interiorly threaded bore is fabricated of a first material and the plurality of threaded inserts are fabricated of a second material that is different from the first material.

8. The system of claim 6, wherein the plurality of threaded inserts include an interiorly threaded surface adapted to mate with an exteriorly threaded flange carried by the vehicle wheel attachment.

9. The system of claim 6, wherein each one of the plurality of threaded inserts has the exteriorly threaded surface defining an exterior diameter that is different from at least one other of the plurality of threaded inserts.

10. The system of claim 8, wherein each one of the plurality of threaded inserts has the interiorly threaded surface defining an interior diameter that is different from at least one other of the plurality of threaded inserts.

11. The system of claim 6, wherein the wheel attachment is a wheel ornament.

12. A method of connecting a wheel attachment to a vehicle wheel hub having a central interiorly threaded bore, comprising modifying the central interiorly threaded bore to mate with an exteriorly threaded flange carried by the wheel attachment.

13. The method of claim 12, including providing the wheel hub fabricated of a first material; and
providing at least one threaded insert fabricated of a second material that is different from the first material and having an exteriorly threaded surface adapted to mate with the central interiorly threaded bore.

14. The method of claim 13, including providing the at least one threaded insert including an interiorly threaded surface adapted to mate with an exteriorly threaded flange carried by the vehicle wheel attachment.

15. The method of claim 14, including mating the vehicle wheel attachment to the at least one threaded insert interiorly threaded surface.

16. The method of claim 13, including providing a plurality of threaded inserts each one having the exteriorly threaded surface defining an exterior diameter that is different from at least one other of the plurality of threaded inserts.

17. The method of claim 14, including providing a plurality of threaded inserts each one having the interiorly threaded surface defining an interior diameter that is different from at least one other of the plurality of threaded inserts.

18. The method of claim 13, including tapping the central interiorly threaded bore to a desired interior diameter to mate with the at least one threaded insert exteriorly threaded surface.

19. The method of claim 18, including mating the tapped central interiorly threaded bore to the at least one threaded insert exteriorly threaded surface.

20. The method of claim 19, including mating the exteriorly threaded flange carried by the wheel attachment to the at least one threaded insert interiorly threaded surface.
